(19) United States
(12) Patent Application Publication
(10) Pub. No.: US 2011/0086253 A1
(43) Pub. Date: Apr. 14, 2011

(54) ELECTROCHEMICAL CELL WITH AN IRREVERSIBLE FUSE

(75) Inventors: Markus Pompetzki, Ellwangen (DE); Markus Kohlberger, Ellwangen (DE); Rainer Hald, Ellwangen (DE); Peter Haug, Ellwangen (DE); Thomas Wöhrle, Ellwangen (DE); Arno Perner, Ellwangen (DE); Calin Wurm, Ellwangen (DE)

(73) Assignees: Varta Microbattery GmbH, Hannover (DE); Volkswagen Varta Microbattery Forschungsgessellschaft mbH & Co. KG, Ellwangen (DE)

(21) Appl. No.: 12/937,558

(22) PCT Filed: Apr. 15, 2009
(86) PCT No.: PCT/EP09/02740

§ 371 Date: Dec. 28, 2010

(30) Foreign Application Priority Data
Apr. 17, 2008 (DE) 10 2008 020 912.0

(51) Int. Cl. H01M 2/34; H01M 10/50

(52) U.S. Cl. 429/62

(57) ABSTRACT

A rechargeable electrochemical cell includes at least one lithium-intercalating electrode; a thin flexible housing, which is closed in a sealed manner, including two films connected to one another by an adhesive or sealing layer; and at least one current output conductor in which an irreversibly tripping thermal fuse is integrated, and the fuse is arranged within the housing and/or embedded in the adhesive or sealing layer.

### RELATED APPLICATIONS

This is a §371 of International Application No. PCT/EP2009/002740, with an international filing date of Apr. 15, 2009 (WO 2009/127396 A1, published Oct. 22, 2009), which is based on German Patent Application No. 10 2008 020 912.0, filed Apr. 17, 2008, the subject matter of which is incorporated by reference.

### TECHNICAL FIELD

This disclosure relates to a rechargeable electrochemical cell having at least one lithium-intercalating electrode and a thin and flexible housing which is closed in a sealed manner and protected against damage caused by short circuits or overcharging.

### BACKGROUND

Because of their high energy density and the associated low weight, rechargeable lithium-ion cells, in particular lithium-polymer cells, are preferably used as energy sources in portable appliances such as portable MP3 players, PDAs, organizers, Notebooks or telephones.

In general, lithium-ion cells or lithium-polymer cells have combustible components, for example, an electrolyte based on organic carbonates. In conjunction with the high energy density of such cells, this represents a potential hazard for the user. Special safety precautions must accordingly be taken to preclude risks for the user, or to keep them as minor as possible.

In particular, lithium-ion cells or lithium-polymer cells can be damaged by surge currents such as those caused by an external short circuit, or by overcharging, and may possibly even be set on fire or may explode. From a statistical point of view, overcharging, in particular, is among the most frequent causes of cell defects.

Lithium-ion cells, in particular lithium-polymer cells, particularly frequently have a graphite-containing anode and a cathode based on lithium cobalt oxide. During the charging process, lithium ions migrate out of the lithium cobalt oxide and are intercalated in the graphite layers of the anode. If such a cell is overcharged, in particular to a voltage of more than 4.2 V, then more lithium ions migrate than can be absorbed by the graphite layers of the anode. As a consequence, highly reactive metallic lithium is deposited on the surface of the anode. If the charging process is continued further and the voltage is correspondingly increased further, in particular to a level of considerably more than 4.2 V, then the components of the electrolyte decompose, leading to severe gassing of the pouch cell. Furthermore, the lithium cobalt oxide structure becomes ever more unstable as a result of the progressive migration of the lithium. In the end, the unit collapses and releases oxidants. These processes lead to severe heating of the cell, which can result in explosion-like combustion.

To avoid this, lithium-ion cells, in particular lithium-polymer cells, are frequently provided with safety electronics which monitor the charging and discharging processes and protect the cell against incorrect handling, in particular also against external short circuits. However, electronic fuses have the disadvantage that they are relatively expensive and can fail in extreme conditions, for example, at high temperatures in the case of solar radiation. Cells are therefore in fact being promoted which can withstand external short circuits or overcharging, even without safety electronics.

### SUMMARY

We provide a rechargeable electrochemical cell including at least one lithium-intercalating electrode, a thin flexible housing, which is closed in a sealed manner, including two films connected to one another by an adhesive or sealing layer, and at least one current output conductor in which an irreversibly tripping thermal fuse is integrated, and the fuse is arranged within the housing and/or embedded in the adhesive or sealing layer.

### BRIEF DESCRIPTION OF THE DRAWINGS

FIG. 1 shows, schematically, the basic design of a cell with an integrated thermal fuse.

FIG. 2 shows the behavior of a cell when overcharged.

FIG. 3 shows the behavior of a comparative cell without an irreversible thermal fuse.

### DETAILED DESCRIPTION

Our rechargeable electrochemical cell has at least one lithium-intercallating electrode. The electrochemical cell is therefore preferably lithium-ion cell, in particular lithium-polymer cell.

The electrochemical cell has a housing comprising two films connected to one another in a sealed manner via an adhesive or sealing layer in such a way that essentially no moisture can enter the housing from the outside, and liquid electrolyte which may be contained in the housing cannot escape.

Particularly preferably, the housing films are aluminum composite films, in particular with the polyamide/aluminum/polypropylene sequence. The housing films in general have a maximum thickness of 160 μm, thus resulting in a very thin and flexible housing.

An electrochemical cell is distinguished in particular in that it has at least one current output conductor in which at least one irreversibly tripping thermal fuse is integrated. In contrast to an electrical fuse, the fuse which is used in our electrochemical cell is therefore not tripped by the current flowing through it, but tripping is in fact caused exclusively by its temperature.

If our cell is overcharged, then the irreversibly tripping thermal fuse responds to the heat created during overcharging and opens the circuit, likewise irreversibly. Further over-charging is then no longer possible, and cells which have already been damaged cannot be over-charged again—in contrast to reversible fuse elements. This is because, in contrast to this, there is a risk in the case of reversibly tripping fuses of the cell being charged again after cooling down and of reaching a point after a plurality of switching-off cycles at which the initially mentioned explosion-like combustion takes place.

In this case, the at least one fuse is preferably arranged within the housing, but can alternatively or additionally also be embedded in the adhesive or sealing layer.

If the fuse is arranged within the housing, then it is preferable for it to be provided with a plastic coating resistant to organic electrolytes. By way of example, adhesive tapes or films based on polyimides, polyethylene, polypropylene, epoxy resin or polyurethane may be used as a coating.

If the fuse is embedded in the adhesive or sealing layer, then there is in general no need for such protective coatings. The term “embedded” is intended to mean that the thermal fuse is substantially completely surrounded by the housing films and can therefore not make direct contact either with any electrolyte which may be contained in the housing or with the surrounding area outside the housing. Furthermore, the arrangement of the thermal fuse within the adhesive or sealing layer has the advantage that no space is lost within the housing, which could be used for active materials.

Preferably, the thermal fuse has a rated tripping temperature between 90° C. and 100° C. It is also preferable for the thermal fuse to have a holding temperature between 50° C. and 60° C. The abovementioned values were in this case each determined at a rated current of 2 A.

The rated tripping temperature is the temperature at which the thermal fuse changes its conductivity and opens the circuit. The holding temperature is the maximum temperature at which the rated current flows through the thermal fuse for a predetermined time (such as 100 hours) without the fuse tripping, that is to say without the conductivity changing and the circuit being opened.

It is furthermore preferable for the thermal fuse to have a maximum temperature limit of 150° C. The “maximum temperature limit” means the temperature at which the thermal fuse retains its mechanical and electrical characteristics after tripping and above which current can flow again.

The internal resistance of our electrochemical cell is preferably in the range between 20 mohm and 100 mohm.

The thermal fuse is particularly preferably a fuse link based on an alloy, in particular based on Roses metal and/or d'Arcets metal.

As is known, Roses metal is an alloy composed of bismuth, lead and tin. The melting point of this alloy is about 98° C., and is therefore below the boiling point of water. In detail, Roses metal consists of 50% bismuth, between 25 and 28% lead and between 22 and 25% tin, and has a density of about 9.32 g/cm³. A similar situation also applies to d'Arcets metal, which is likewise an alloy composed of bismuth, tin and lead, but which has a somewhat lower melting point of about 93.75° C.

The housing films of an electrochemical cell are, in particular, metal/plastic composite films such as the aluminum composite film already mentioned above. It is particularly preferable for these composite films to have a metal layer which is coated with an electrical insulator, for example, an insulating plastic film or an insulating adhesive tape, on its side facing the housing interior. In this case, the metal is preferably copper, aluminum or an alloy of these metals. A further layer, in particular a thin plastic layer, for example, composed of a polyester, can be arranged on the outside of the metal layer.

It is preferable for the insulating layer to have a thickness between 20 μm and 70 μm on the side of the metal layer facing the housing interior. This is because it has been found that this range ensures that the thermal fuse of an electrochemical element responds particularly quickly. This is because, in the event of overcharging or a short circuit, the heat propagates, starting from the electrodes of the electrochemical cell, inter alia also via the housing films of an electrochemical cell. However, the heat can be passed on to the thermal fuse with relative inertia if the insulating layer is excessively thick.

The insulating layer is particularly preferably a polyolefin layer, for example, a layer composed of polypropylene as in the case of the aluminum composite film mentioned above.

As already indicated, the two housing films can be connected to one another by adhesive bonding or else by other measures which are routine in the art, for example, by welding and/or hot sealing. Suitable measures are known.

Our electrochemical cell preferably has at least one electrochemical individual element with two electrodes arranged like a stack. A separator is generally always arranged between the electrodes, such that the at least one electrochemical individual element normally comprises a sequence of negative electrode/separator/positive electrode.

The at least one positive electrode may, for example, have lithium cobalt oxide as the active material. By way of example, graphite can be used as the active material for the at least one negative electrode. In general, the separator is composed of a preferably porous plastic, for example a polyolefin.

Furthermore, the electrochemical cell may, of course, also have an electrolyte, for example, an organic electrolyte based on carbonate, as already mentioned initially.

Those advantages and further advantages will become evident from the description of the examples which now follow and from the drawings. Individual features may be implemented on their own or in combination with one another. The described examples are intended only for explanatory purposes and better understanding and should not in any way be regarded as restrictive.

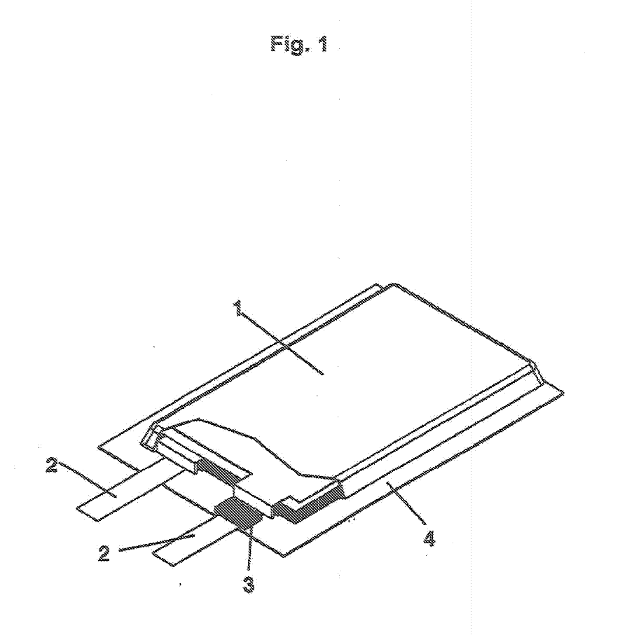

Turning now to the drawings, as can be seen in FIG. 1, an irreversibly tripping thermal fuse element 3 is integrated, for example, welded in one of the output conductors 2 of the cell 1, which output conductor 2 consists, for example, of nickel, copper or aluminum. The fuse element 3 is arranged such that it is arranged in the sealing layer 4 of the cell. When the housing is closed, the fuse element 3 is substantially completely sheathed by the housing films.

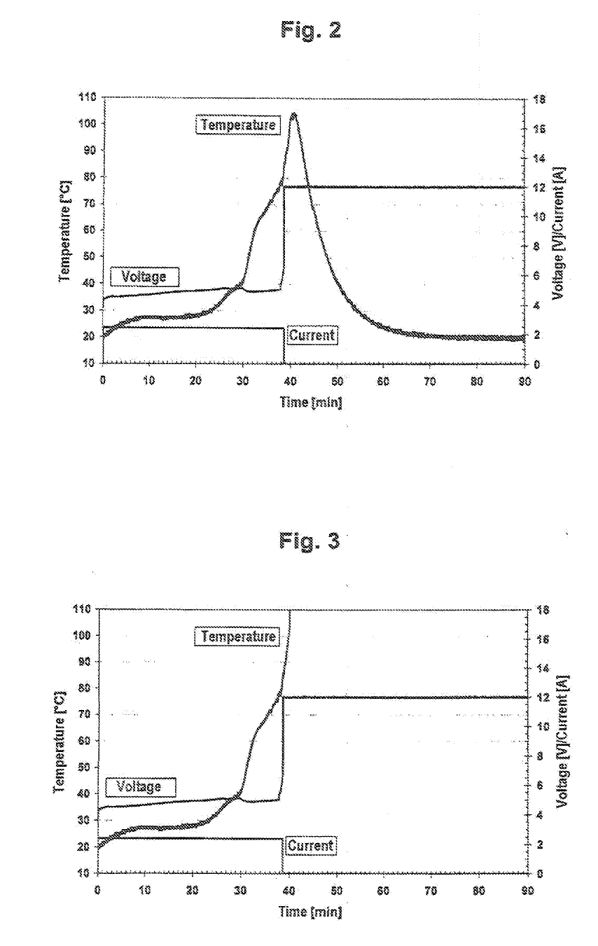

As FIG. 2 shows, during an overload test with a cell such as this, the temperature rose gradually up to about 38 minutes. During the process, the current and voltage remained substantially constant. At 38 minutes, the voltage rose suddenly from about 5.5 V to 12 V, while the current fell to 0. Within a few minutes, the temperature rose to more than 100° C., and then slowly fell to room temperature.

As shown in FIG. 3, the current, voltage and temperature in the comparative cell behaved analogously up to 38 minutes. In this case as well, the current then fell to 0, while the voltage rose to 12 V. After a few minutes, the temperature rose exponentially, and the cell burned.

1-7. (canceled)

8. A rechargeable electrochemical cell comprising:
at least one lithium-intercalating electrode;
a thin flexible housing, which is closed in a sealed manner, comprising two films connected to one another by an adhesive or sealing layer; and
at least one current output conductor in which an irreversibly tripping thermal fuse is integrated, and the fuse is arranged within the housing and/or embedded in the adhesive or sealing layer.

9. The electrochemical cell of claim 8, wherein the thermal fuse has a rated tripping temperature between 90° C. and 100° C., and/or a holding temperature between 50° C. and 60° C. as measured at a rated current of 2 A.

10. The electrochemical cell of claim 8, wherein the thermal fuse is a fuse link based on an alloy.

11. The electrochemical cell of claim 10, wherein the alloy is based on Roses metal and/or d'Arcets metal.

12. The electrochemical cell of claim 8, wherein the housing films are metal/plastic composite films.

13. The electrochemical cell of claim 12, wherein the metal/plastic composite films have a metal layer coated with an electrical insulator on a side facing the housing interior.

14. The electrochemical cell of claim 13, wherein the insulating layer has a thickness between 20 μm and 70 μm.

15. The electrochemical cell of claim 13, wherein the insulating layer is a polyolefin layer.

16. The electrochemical cell of claim 14, wherein the insulating layer is a polyolefin layer.
